(19) United States
(12) Patent Application Publication
(10) Pub. No.: US 2026/0281579 A1
(43) Pub. Date: Sep. 17, 2026

(54) PIXEL ARRAY AND IMAGE SENSOR

(71) Applicant: Shyh-Feng CHEN, Hsinchu County (TW)

(72) Inventor: Shyh-Feng CHEN, Hsinchu County (TW)

(21) Appl. No.: 19/560,172

(22) Filed: Mar. 9, 2026

(30) Foreign Application Priority Data
Mar. 11, 2025 (TW) 114109005

(51) Int. Cl. H04N 25/77; H04N 23/80

(52) U.S. Cl. CPC H04N 25/77; H04N 23/80

(57) ABSTRACT

A pixel array and an image sensor including the pixel array are proposed. The pixel array includes a plurality of pixel units and a plurality of feature operating units. Each of the pixel units is configured to generate a pixel signal. Each of the feature operating units is coupled to at least two of the pixel units and configured to perform a feature operation on at least two pixel signals generated by the at least two of the pixel units so as to generate an image feature signal corresponding to the feature operation. The feature operation performed by one of the feature operating units is identical to or different from that performed by another of the feature operating units.

### RELATED APPLICATIONS

This application claims priority to Taiwan Application Serial Number 114109005, filed Mar. 11, 2025, which is herein incorporated by reference.

### BACKGROUND

### Technical Field

The present disclosure relates to a pixel array and an image sensor. More particularly, the present disclosure relates to a pixel array and an image sensor that can quickly output image feature signals.

### Description of Related Art

An image sensor is a device configured to capture two-dimensional (2D) or three-dimensional (3D) images of a target object. The image sensor can, for example, be a charge-coupled device (CCD) sensor or a complementary metal-oxide-semiconductor (CMOS) sensor.

A pixel array in a conventional image sensor can output a plurality of pixel signals. Each pixel signal must undergo analog-to-digital conversion through an analog-to-digital converter (ADC) before being provided to a backend device to subsequently perform image feature preprocessing, such as convolutional neural network (CNN) operations, thereby generating image feature values. Accordingly, image sensors have an upper specification limit on frame rate. Moreover, a rolling shutter sensor may suffer from synchronization issues, such as the jello effect. On the other hand, as the number of pixels continues to increase, the conversion workload of the ADC correspondingly increases. The backend device likewise consumes more system resources in order to obtain the image feature values. Accordingly, there is currently a lack of an image sensor capable of generating image feature values in real time in the market, and thus related industries are seeking solutions thereto.

### SUMMARY

According to one aspect of the present disclosure, a pixel array includes a plurality of pixel units and a plurality of feature operating units. Each of the pixel units is configured to generate a pixel signal. Each of the feature operating units is coupled to at least two of the pixel units and configured to perform a feature operation on at least two pixel signals generated by the at least two of the pixel units so as to generate an image feature signal corresponding to the feature operation. The feature operation performed by one of the feature operating units is identical to or different from that performed by another of the feature operating units.

According to another aspect of the present disclosure, an image sensor includes a pixel array and a driving unit. The pixel array includes a plurality of pixel units and a plurality of feature operating units. Each of the pixel units is configured to generate a pixel signal. Each of the feature operating units is coupled to at least two of the pixel units and configured to perform a feature operation on at least two pixel signals generated by the at least two of the pixel units so as to generate an image feature signal corresponding to the feature operation, and the feature operation performed by one of the feature operating units is identical to or different from that performed by another of the feature operating units. The driving unit is connected to the pixel array and configured to output a control signal to the pixel array, and each of the pixel units is controlled by the control signal to generate the pixel signal.

### BRIEF DESCRIPTION OF THE DRAWINGS

The present disclosure can be more fully understood by reading the following detailed description of the embodiment, with reference made to the accompanying drawings as follows:

FIG. 1 is a block diagram illustrating an image sensor according to a first embodiment of the present disclosure.

FIG. 2 is a schematic diagram illustrating a pixel array of the image sensor shown in FIG. 1.

FIG. 3 is a partial schematic diagram illustrating the pixel array shown in FIG. 2.

FIG. 4 is a partial schematic diagram illustrating a pixel array according to a second embodiment of the present disclosure.

FIG. 5 is a partial schematic diagram illustrating a pixel array according to a third embodiment of the present disclosure.

FIG. 6 is a partial schematic diagram illustrating a pixel array according to a fourth embodiment of the present disclosure.

FIG. 7 is a partial schematic diagram illustrating a pixel array according to a fifth embodiment of the present disclosure.

FIG. 8 is a partial schematic diagram illustrating a pixel array according to a sixth embodiment of the present disclosure.

FIG. 9 is a partial schematic diagram illustrating a pixel array according to a seventh embodiment of the present disclosure.

FIG. 10 is a partial schematic diagram illustrating a pixel array according to an eighth embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected” to another element, it can be directly connected to the other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

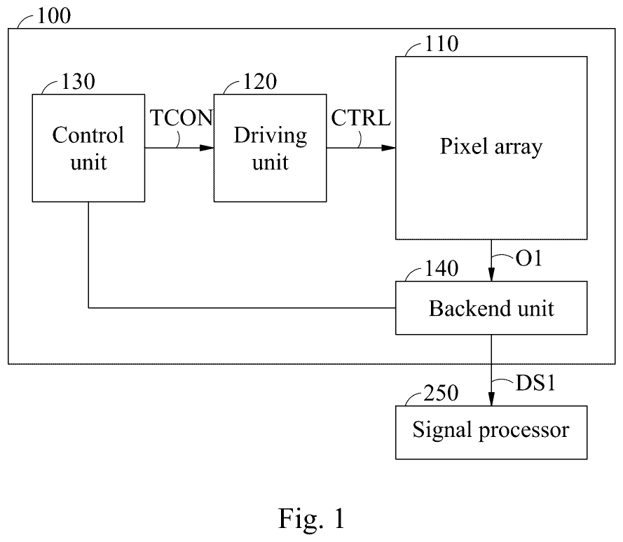

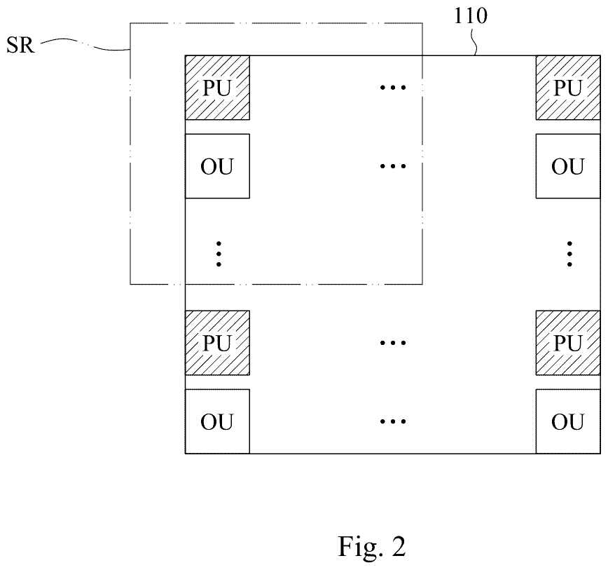

Please refer to FIGS. 1 and 2. FIG. 1 is a block diagram illustrating an image sensor 100 according to a first embodiment of the present disclosure. FIG. 2 is a schematic diagram illustrating a pixel array 110 of the image sensor 100 shown in FIG. 1.

The image sensor 100 can be installed in an electronic device having an image sensing or light detecting function, and is configured to capture a target (e.g., a person, an object, or a scene) to obtain image information of the target. For example, the image sensor 100 can be a complementary metal-oxide-semiconductor (CMOS) sensor, and is disposed inside electronic devices such as digital cameras, video cameras, smartphones, wearable devices, computers, and/or similar devices.

As shown in FIGS. 1 and 2, the image sensor 100 includes a pixel array 110 and a driving unit 120. The pixel array 110 includes a plurality of pixel units PU, a plurality of feature operating units OU, a plurality of row lines (not shown), and a plurality of column lines (not shown). The pixel units PU and the feature operating units OU are electrically connected to the row lines and the column lines, and are arranged in an array. The pixel units PU and/or the feature operating units OU in the same column direction can be connected to the same column line, and those in the same row direction can be connected to the same row line.

In some embodiments, each pixel unit PU can be, for example, a pixel circuit having a photoelectric conversion element, which can be, but is not limited to, a three-transistor (3T) pixel circuit, a four-transistor (4T) pixel circuit, or a single photodiode circuit. Each of the pixel units PU can sense light reflected from the target by using the photoelectric conversion element, and generate a pixel signal based on the sensed reflected light.

Each of the feature operating units OU is coupled to at least two of the pixel units PU, and configured to perform a feature operation on at least two pixel signals generated by the at least two of the pixel units PU so as to generate an image feature signal corresponding to the feature operation. The feature operation performed by one of the feature operating units OU can be identical to or different from that performed by another of the feature operating units OU. In some embodiments, each feature operating unit OU can be, for example, an analog circuit configured to execute a task (i.e., the aforementioned feature operation). The analog circuit can include at least one sub-circuit component. The sub-circuit component can include circuit elements (e.g., passive elements such as capacitors, resistors, or inductors), and can further include transistors and interconnections between the transistors and the circuit elements.

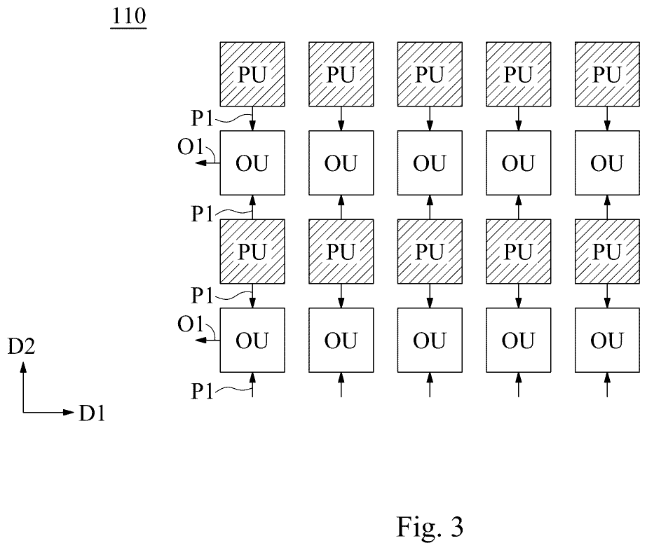

Please refer to FIG. 3. FIG. 3 is a partial schematic diagram illustrating the pixel array 110 shown in FIG. 2. Specifically, FIG. 3 shows an arrangement example of the pixel units PU and the feature operating units OU located within a framed region SR of the pixel array 110 in FIG. 2, and the framed region SR can be any region in the pixel array 110. As shown in FIG. 3, the pixel units PU and the feature operating units OU in the first embodiment can be selectively distributed in a regular array to form a two-dimensional array structure. The feature operating units OU are located between the pixel units PU, and a number of the pixel units PU is equal to a number of the feature operating units OU. In addition, the pixel units PU can be grouped along a row direction D1 (i.e., a horizontal direction) to form a plurality of first row groups, and the feature operating units OU can be grouped along the row direction D1 to form a plurality of second row groups. The first row groups and the second row groups are alternately arranged at intervals along a column direction D2 (i.e., a vertical direction) to form a striped pattern. In particular, each feature operating unit OU in the second row groups can be electrically connected to two pixel units PU located on two sides thereof along the column direction D2, and receive two pixel signals P1. Furthermore, each pixel unit PU in the first row groups can replicate and transmit its generated pixel signal P1 to two different feature operating units OU via an electrical connection unit (e.g., a current mirror circuit).

After receiving the two pixel signals P1, each feature operating unit OU can perform the feature operation on the two pixel signals P1, such as addition, subtraction, multiplication, division, or averaging, but the present disclosure is not limited thereto. For example, the feature operating unit OU in the first embodiment can be a single resistor. The two pixel units PU located on two sides of the feature operating unit OU are connected in parallel, and the two pixel signals P1 (e.g., current signals) are converted by the resistor to generate an image feature signal O1 (e.g., a voltage signal). Therefore, when the feature operating unit OU is a resistor, the functions of current summation and voltage signal output can be achieved.

In some embodiments, the driving unit 120 can be, for example, a pixel driver. The driving unit 120 is electrically connected to the pixel array 110 and configured to output a control signal CTRL to the pixel array 110. Each of the pixel units PU in the pixel array 110 is controlled by the control signal CTRL to generate the pixel signal P1.

In some embodiments, the image sensor 100 can further include a control unit 130 and a backend unit 140. The control unit 130 can be, for example, a timing controller, and is electrically connected to the driving unit 120 and the backend unit 140. The control unit 130 can be configured to generate a control signal TCON to control the operation and/or timing of the driving unit 120. The driving unit 120 can decode the control signal TCON (e.g., address signals) received from the control unit 130, and output the control signal CTRL to the pixel array 110 according to the decoded control signal TCON so as to select at least one row among a plurality of rows of the pixel array 110. For example, the driving unit 120 can generate a selection signal for selecting one of the plurality of rows. The pixel array 110 selects the one of the plurality of rows according to the selection signal received from the driving unit 120 to generate the pixel signal P1.

The backend unit 140 can be, for example, an analog-to-digital converter (ADC), and is electrically connected to the pixel array 110 and the control unit 130. The backend unit 140 can receive another control signal from the control unit 130, and its operation and/or timing are controlled by the another control signal. The backend unit 140 can receive a plurality of image feature signals O1 generated by the feature operating units OU in the pixel array 110, and convert the image feature signals O1 into a plurality of digital signals DS1.

In addition, the backend unit 140 can output the digital signals DS1 to a signal processor 250 outside the image sensor 100, so that the signal processor 250 performs a signal analysis on the digital signals DS1. In some embodiments, the signal processor 250 can be, but is not limited to, a neural processing unit (NPU), a central processing unit (CPU), or a graphics processing unit (GPU). The signal processor 250 can perform neural network operations on the digital signals DS1, such as mathematical operations for artificial intelligence (AI) image recognition.

In other embodiments, a number of sub-circuit components within the feature operating unit can be plural. Based on the sub-circuit components respectively corresponding to multiple feature operations, the feature operating unit can perform different feature operations on the received pixel signals to generate multiple image feature signals corresponding to the feature operations. In other words, after receiving the pixel signals, the feature operating unit can output one or more feature results (i.e., one or more image feature signals) based on the feature operations as image feature values for AI image recognition. In addition, a first feature result output by each feature operating unit can form a feature image. Therefore, multiple feature results can form multiple different feature images, such that a single pixel image can generate one or more feature images after passing through the feature operating unit. The collection of these feature images can contain multiple different features of the original pixel image, thereby providing very rich input information for neural network operations in the signal processor and enabling more accurate image recognition results.

Accordingly, in the image sensor 100 of the present disclosure, by disposing the feature operating units OU within the pixel array 110, the pixel array 110 can directly and instantaneously output one or more image feature signals O1 or digital signals DS1 corresponding to the target, instead of merely outputting the pixel signals P1 to the signal processor 250. Therefore, the processes and resources required for the signal processor 250 to perform analog-to-digital conversion and feature pre-processing of the pixel signals P1 can be eliminated. Various arrangement embodiments of the pixel units PU and the feature operating units OU will be illustrated below in conjunction with the drawings; however, the present disclosure is not limited to the following embodiments.

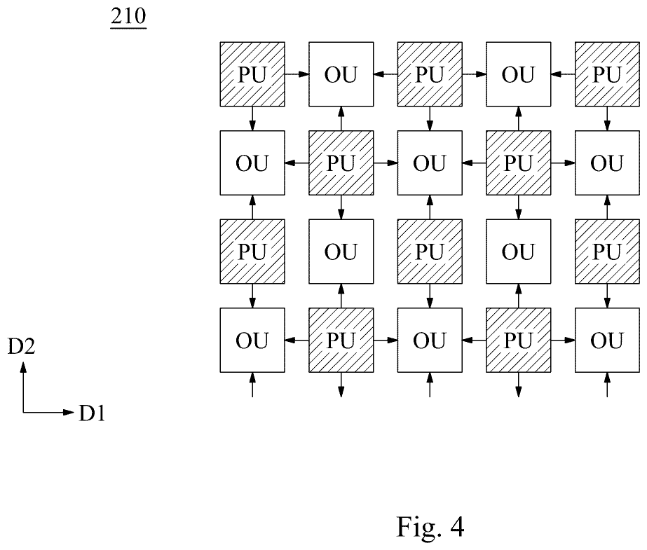

Please refer to FIG. 4. FIG. 4 is a partial schematic diagram illustrating a pixel array 210 according to a second embodiment of the present disclosure. As shown in FIG. 4, the difference between the pixel array 210 and the pixel array 110 of the first embodiment lies in that a plurality of pixel units PU and a plurality of feature operating units OU are alternately arranged to form a grid-like pattern. In addition, each of the pixel units PU can transmit a pixel signal to the feature operating units OU adjacent thereto. That is, each pixel unit PU can be electrically connected to four feature operation units OU respectively adjacent thereto in the positive and negative directions along the column direction D1 and in the positive and negative directions along the row direction D2, and transmit the pixel signal to the four feature operating units OU. In other words, each feature operating unit OU can simultaneously receive four pixel signals from adjacent pixel units PU located at its upper, lower, left, and right sides.

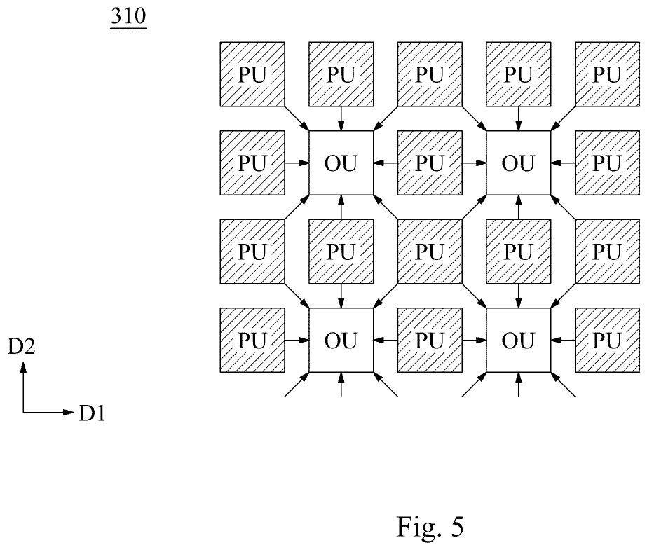

Please refer to FIG. 5. FIG. 5 is a partial schematic diagram illustrating a pixel array 310 according to a third embodiment of the present disclosure. As shown in FIG. 5, the difference between the pixel array 310 and the pixel arrays 110, 210 of the first and second embodiments lies in that a number of pixel units PU is greater than a number of feature operating units OU, and each feature operating unit OU can be surrounded by a plurality of pixel units PU (for example, eight pixel units PU). Therefore, compared with the first and second embodiments, the feature operating units OU in the pixel array 310 can obtain more pixel signals from surrounding pixel units PU to generate an image feature signal.

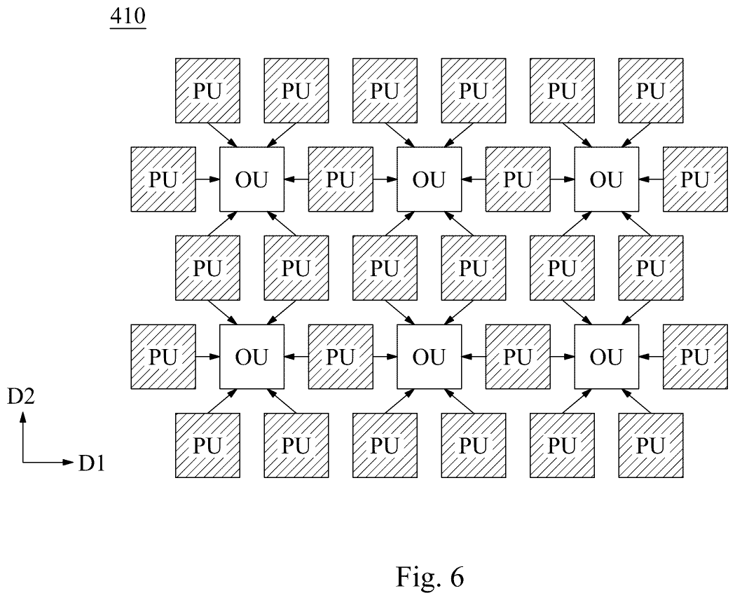

Please refer to FIG. 6. FIG. 6 is a partial schematic diagram illustrating a pixel array 410 according to a fourth embodiment of the present disclosure. As shown in FIG. 6, the pixel array 410 is similar to the pixel array 310 of the third embodiment. The difference lies in that the plurality of pixel units PU and the plurality of feature operating units OU can be selectively distributed in an irregular array to form a two-dimensional array structure. In addition, a plurality of electrical connection units (not shown) can be correspondingly disposed in the pixel array 410 based on the irregular array distribution of the pixel units PU and the feature operating units OU so as to electrically connect the pixel units PU to the feature operating units OU.

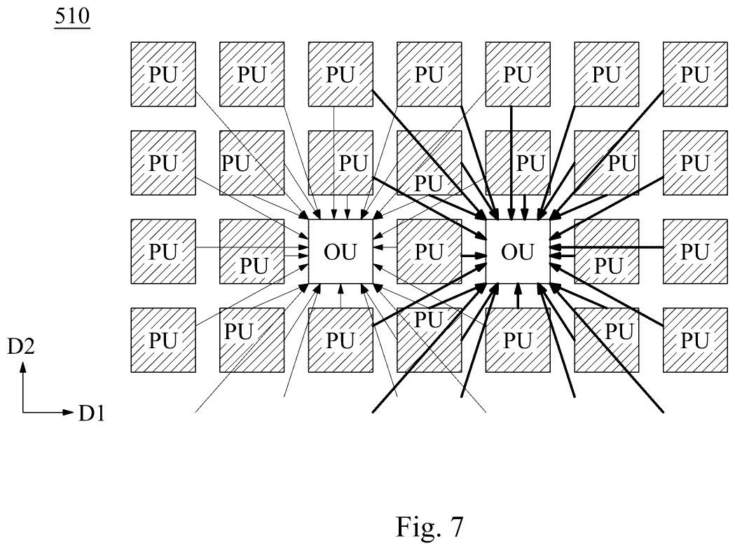

Please refer to FIG. 7. FIG. 7 is a partial schematic diagram illustrating a pixel array 510 according to a fifth embodiment of the present disclosure. As shown in FIG. 7, the difference between the pixel array 510 and the pixel array 310 of the third embodiment lies in that each feature operating unit OU is electrically connected not only to the eight pixel units PU adjacent thereto, but can further be coupled to pixel units PU at more hierarchical levels. In other words, each feature operating unit OU can be electrically connected, via electrical connection units (not shown), to pixel units PU that are not immediately adjacent thereto. Therefore, compared with the third embodiment, each of the feature operating units OU in the pixel array 510 can obtain more pixel signals from surrounding pixel units PU to generate an image feature signal, such that a number of the pixel units PU can be far greater than a number of feature operating units OU. In other embodiments, since each pixel unit can also be electrically connected, via electrical connection units, to multiple feature operating units that are not immediately adjacent thereto, the number of pixel units in the pixel array can be less than the number of feature operating units, enabling the pixel array to output more types of feature results for use by backend devices with different functions.

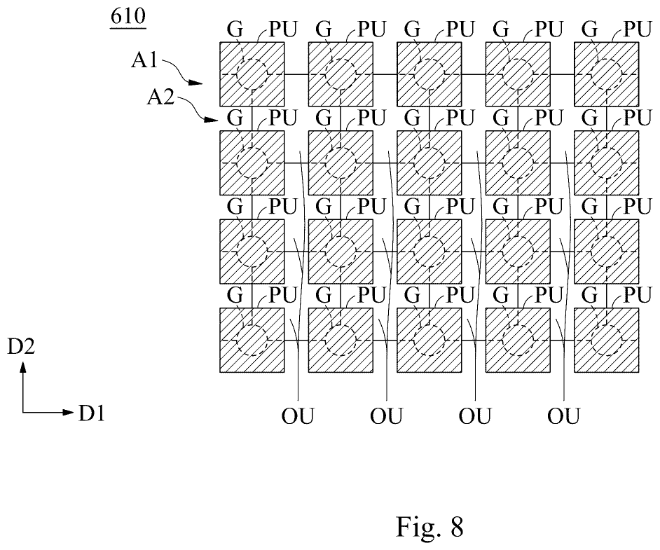

Please refer to FIG. 8. FIG. 8 is a partial schematic diagram illustrating a pixel array 610 according to a sixth embodiment of the present disclosure. As shown in FIG. 8, the difference between the pixel array 610 and the pixel array 110 of the first embodiment lies in that the pixel array 610 has a three-dimensional array structure. In detail, a plurality of pixel units PU in the pixel array 610 are arranged in an array to form a first array structure A1, a plurality of feature operating units OU are arranged in an array to form a second array structure A2, and the first array structure A1 is stacked on the second array structure A2.

In some embodiments, the pixel array 610 can further include a first substrate (not shown) and a second substrate (not shown) stacked on each other. The first array structure A1 is disposed on the first substrate, and the second array structure A2 is disposed on the second substrate. Each pixel unit PU on the first substrate has a node G. The node G of each pixel unit PU can be electrically connected, via an electrical connection unit, to the feature operating unit OU on the second substrate to transmit the pixel signal. Specifically, each feature operating unit OU can have a square shape, and is electrically connected to the pixel units PU overlapping therewith, and receive the pixel signals generated by the overlapping pixel units PU.

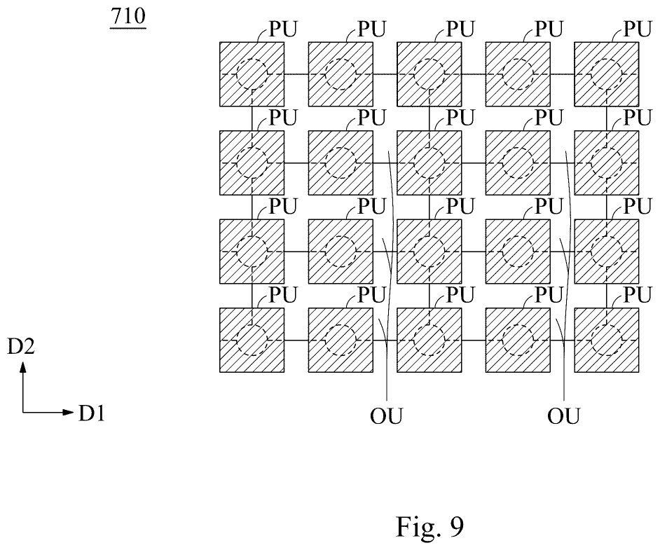

Please refer to FIG. 9. FIG. 9 is a partial schematic diagram illustrating a pixel array 710 according to a seventh embodiment of the present disclosure. As shown in FIG. 9, the pixel array 710 is similar to the pixel array 610 of the sixth embodiment. The difference lies in that the feature operating units OU on the second substrate can be rectangular. In other embodiments, the feature operating units can also have a circular shape, an elliptical shape, or other shapes.

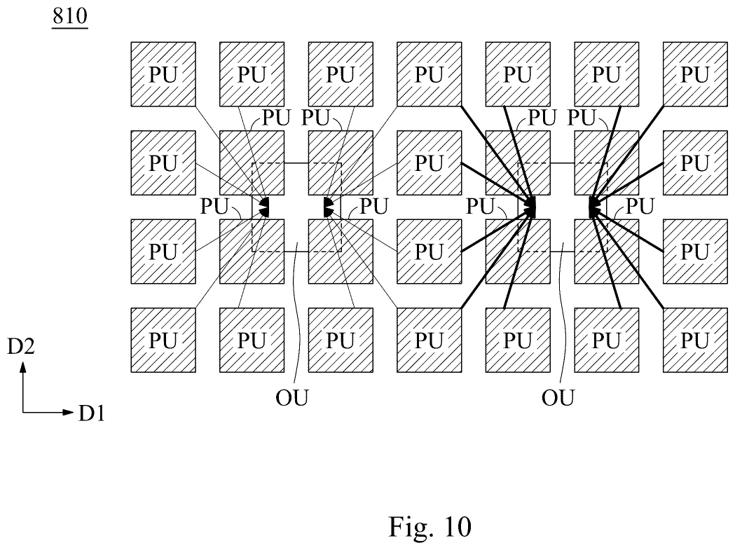

Please refer to FIG. 10. FIG. 10 is a partial schematic diagram illustrating a pixel array 810 according to an eighth embodiment of the present disclosure. As shown in FIG. 10, the pixel array 810 is similar to the pixel array 610 of the sixth embodiment. The difference lies in that each feature operating unit OU on the second substrate is electrically connected not only to the pixel units PU on the first substrate overlapping therewith, but can further be coupled to pixel units PU at more hierarchical levels in the upper layer. In other words, each feature operating unit OU can be electrically connected, via electrical connection units (not shown), to pixel units PU on the first substrate that do not overlap therewith. Therefore, compared with the sixth embodiment, each of the feature operating units OU in the pixel array 810 can obtain more pixel signals from the pixel units PU located in the upper layer to generate an image feature signal.

In summary, the pixel array and the image sensor of the present disclosure have the following advantages. First, the feature operating unit can simultaneously receive multiple pixel signals from adjacent, surrounding, or upper-layer pixel units to generate one or more image feature signals, thereby eliminating the processes and resources required for analog-to-digital conversion and feature pre-processing of the pixel signals. Second, through the structural configuration between the feature operating units and the pixel units, fast output (i.e., real-time computation by the feature operating units) and parallel computation (i.e., multiple feature operating units among the pixel units can operate simultaneously) can be achieved, enabling the image feature signals to be output very rapidly. Third, image feature values are the most important input parameters for AI image recognition and have a decisive impact on recognition performance. Therefore, the pixel array of the present disclosure has the function of rapidly outputting image feature signals, thereby contributing to the field of image recognition technology.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A pixel array, comprising:
a plurality of pixel units, wherein each of the pixel units is configured to generate a pixel signal; and
a plurality of feature operating units, wherein each of the feature operating units is coupled to at least two of the pixel units and configured to perform a feature operation on at least two pixel signals generated by the at least two of the pixel units so as to generate an image feature signal corresponding to the feature operation;
wherein the feature operation performed by one of the feature operating units is identical to or different from that performed by another of the feature operating units.

2. The pixel array of claim 1, wherein the pixel units and the feature operating units are selectively distributed in a regular array or in an irregular array to form a two-dimensional array structure, and the feature operating units are located between the pixel units.

3. The pixel array of claim 1, wherein the pixel units are arranged in an array to form a first array structure, the feature operating units are arranged in an array to form a second array structure, and the first array structure is stacked on the second array structure.

4. The pixel array of claim 3, wherein the each of the feature operating units is electrically connected to the at least two of the pixel units overlapping therewith and receives at least two pixel signals generated by the at least two of the pixel units.

5. The pixel array of claim 1, wherein each of the pixel units transmits the pixel signal to at least one of the feature operating units adjacent thereto.

6. The pixel array of claim 1, wherein a number of the pixel units is greater than or equal to a number of the feature operating units.

7. An image sensor, comprising:
a pixel array, comprising:
a plurality of pixel units, wherein each of the pixel units is configured to generate a pixel signal; and
a plurality of feature operating units, wherein each of the feature operating units is coupled to at least two of the pixel units and configured to perform a feature operation on at least two pixel signals generated by the at least two of the pixel units so as to generate an image feature signal corresponding to the feature operation, and the feature operation performed by one of the feature operating units is identical to or different from that performed by another of the feature operating units; and
a driving unit connected to the pixel array and configured to output a control signal to the pixel array, wherein each of the pixel units is controlled by the control signal to generate the pixel signal.

8. The image sensor of claim 7, further comprising:
a backend unit connected to the pixel array and configured to receive a plurality of the image feature signals generated by the feature operating units and convert the image feature signals into a plurality of digital signals;
wherein the backend unit is configured to output the digital signals to a signal processor, so that the signal processor performs a signal analysis on the digital signals.

9. The image sensor of claim 7, wherein the pixel units and the feature operating units are selectively distributed in a regular array or in an irregular array to form a two-dimensional array structure, and the feature operating units are located between the pixel units.

10. The image sensor of claim 7, wherein the pixel units are arranged in an array to form a first array structure, the feature operating units are arranged in an array to form a second array structure, and the first array structure is stacked on the second array structure.
